(19) United States
(12) Patent Application Publication
(10) Pub. No.: US 2014/0026548 A1
(43) Pub. Date: Jan. 30, 2014

(54) METHOD AND A DEVICE FOR REDUCING VIBRATIONS IN A WORKING MACHINE

(71) Applicants: Bo Vigholm, Stora Sundby (SE); Jan Karlsson, Eskilstuna (SE)

(72) Inventors: Bo Vigholm, Stora Sundby (SE); Jan Karlsson, Eskilstuna (SE)

(73) Assignee: VOLVO CONSTRUCTION EQUIPMENT AB, Eskilstuna (SE)

(21) Appl. No.: 14/111,569

(22) PCT Filed: Apr. 15, 2011
(86) PCT No.: PCT/SE2011/000070

§ 371 Date: Oct. 14, 2013

(51) Int. Cl. E02F 9/22; F15B 21/00

(52) U.S. Cl. CPC E02F 9/2278; F15B 21/008
USPC 60/327; 60/431

(57) ABSTRACT

A method for reducing vibrations in a working machine is provided. The working machine includes a hydraulic system with a hydraulic machine for providing hydraulic fluid to at least one working function. The hydraulic machine is driven by a drive source haying a variable speed of rotation. The method includes identifying a resonance frequency for the working machine, and controlling the drive source so as to counteract waves with the resonance frequency.

### BACKGROUND AND SUMMARY

The invention relates to a method for reducing vibrations in a working machine.

The invention is applicable on working machines within the fields of industrial construction machines, in particular wheel loaders. Although the invention will be described hereinafter with respect to a wheel loader, the invention is not restricted to this particular machine, but may also be used in other heavy working machines, such as articulated haulers, dump trucks, graders, excavators or other construction equipment.

A working machine is provided with a bucket, container or other type of implement for digging, lifting, carrying and/or transporting a load.

For example, a wheel loader has a load arm unit for raising and lowering an implement, such as a bucket. The load arm unit comprises a number of hydraulic cylinders for movement of a load arm and the implement attached to the load arm. A pair of hydraulic cylinders is arranged for lifting the load arm and a further hydraulic cylinder is arranged for tilting the implement relative to the load arm.

In addition to the hydraulic cylinders, the hydraulic system of the wheel loader comprises at least one pump for providing hydraulic fluid to the hydraulic cylinders of the load arm unit.

The hydraulic system of a wheel loader is usually a so called load sensing system (LS system). This means that the pump which provides the hydraulic system with hydraulic fluid receives a signal representing the current load pressure of a hydraulic cylinder in operation. The pump is controlled to provide a pressure which somewhat exceeds the load pressure of the hydraulic cylinder. Hereby a flow of hydraulic fluid to the current hydraulic cylinder is created.

In a hydraulic system, such as a LS system, a certain speed and displacement of the hydraulic pump may give rise to waves, such as acoustic waves, pulsations in the hydraulic fluid and/or vibrations in mechanical components, which in turn can give rise to unwanted vibrations in a working machine. Since the flow of hydraulic fluid to the working functions of the working machine is determined by the demanded speed of the implement associated with the current working function, such a speed demand may cause the pump to be driven with a speed and displacement that in turn will cause waves at a resonance frequency. Also auxiliary equipment driven by the hydraulic system, such as a cooling fan, may give rise to resonance frequency waves.

It is desirable to provide a method defined by way of introduction, by which method vibrations due to resonance frequency waves in a working machine can be reduced.

The invention is based, according to an aspect thereof, on the insight that a hydraulic system, for example a hydraulic system of the load sensing type, can give rise to waves for a certain speed of the hydraulic pump. Such waves in turn can give rise to unwanted vibrations. By the provision of a method comprising the steps of identifying a resonance frequency for the working machine and controlling the drive source, preferably an electric motor, so as to counteract waves with the resonance frequency, unwanted vibrations in the working machine can be reduced or avoided.

The invention also relates, according to an aspect thereof, to a device for reducing vibrations in a working machine.

Further advantages and advantageous features of the invention are disclosed in the following description and in the claims.

### BRIEF DESCRIPTION OF THE DRAWINGS

With reference to the appended drawings, below follows a more detailed description of embodiments of the invention cited as examples.

In the drawings:

FIG. 1 is a lateral view illustrating a wheel loader having a bucket for loading operations, and a hydraulic system for operating the bucket and steering the wheel loader,

FIG. 2 is a schematic block diagram illustrating the method according to the invention, and

FIG. 3 is a schematic illustration of a working machine, and a hydraulic system of a working machine to which the method according to the invention can be applied.

### DETAILED DESCRIPTION

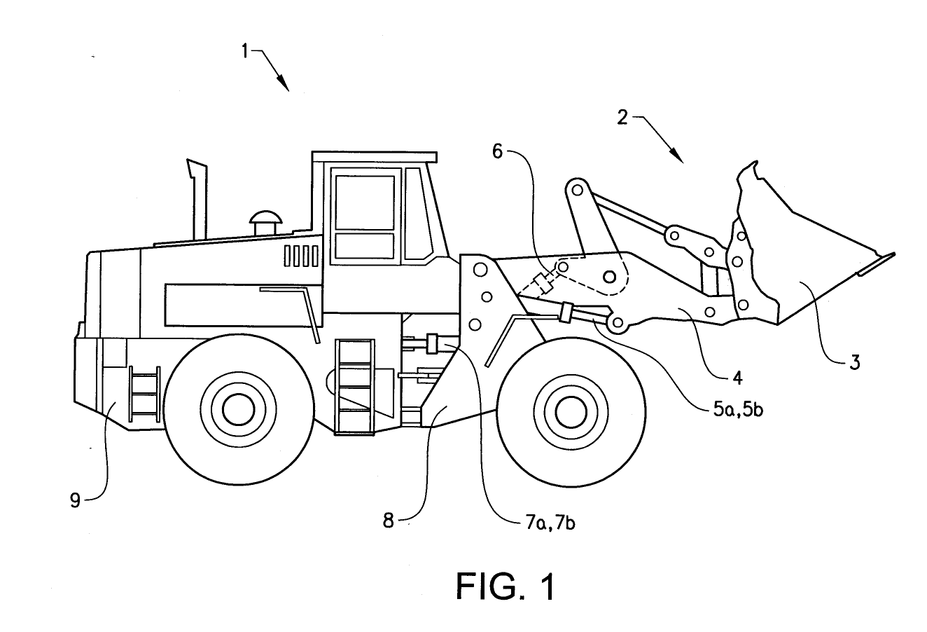

FIG. 1 is an illustration of a working machine 1 in the form of a wheel loader having an implement 2. The term “implement” is intended to comprise any kind of tool using hydraulics, such as a bucket, a fork or a gripping tool arranged on a wheel loader, or a container arranged on an articulated hauler. The implement illustrated is a bucket 3 which is arranged on an arm unit 4 for lifting and lowering the bucket 3, and further the bucket 3 can be tilted relative to the arm unit 4. The wheel loader 1 is provided with a hydraulic system comprising at least one hydraulic machine (not shown in FIG. 1). The hydraulic machine can be a hydraulic pump, although it is preferred that the hydraulic machine can work as a hydraulic pump as well as a hydraulic motor with a reversed flow of hydraulic fluid. Such a hydraulic machine with said both functions can be used as a pump for providing the hydraulic system with hydraulic fluid, for example to lift and tilt the bucket, and as a hydraulic motor for recuperation of energy, for example during a lowering operation of the implement 2. In the example embodiment illustrated in FIG. 1 the hydraulic system comprises two hydraulic cylinders 5a, 5b for the operation of the arm unit 4 and a hydraulic cylinder 6 for tilting the bucket relative to the am unit 4. Furthermore the hydraulic system comprises two hydraulic cylinders 7a, 7b arranged on opposite sides of the wheel loader for turning the wheel loader by means of relative movement of a from body part 8 and a rear body part 9. In other words; the working machine is frame-steered by means of the steering cylinders 7a, 7b.

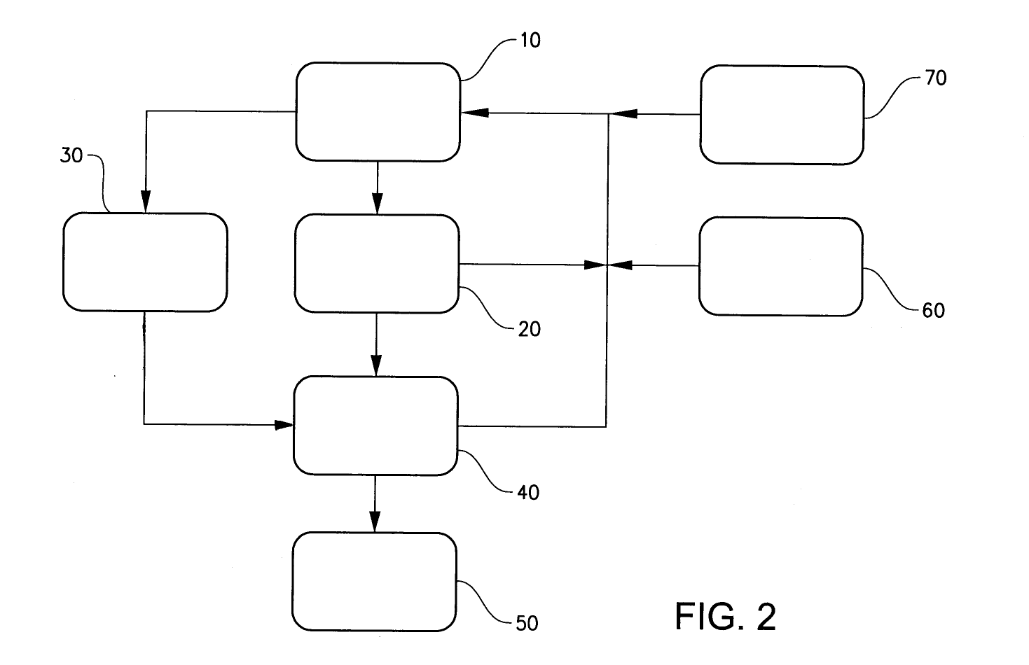

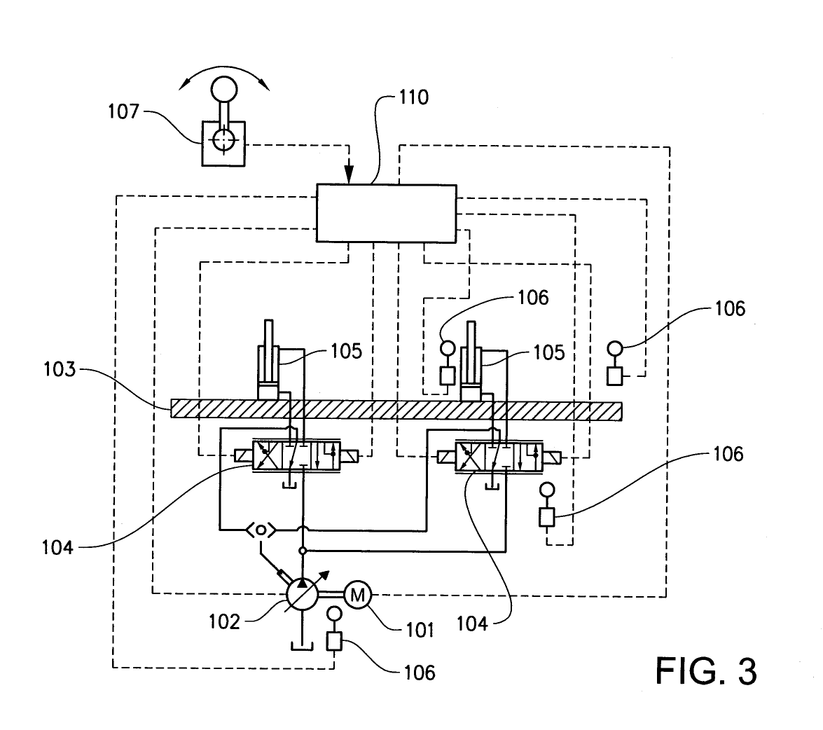

The method for reducing vibrations in a working machine according to the invention will hereinafter be described with reference to FIGS. 2 and 3. In FIG. 2 a schematic block diagram is illustrated. This block diagram shows how the system can work to identify a resonance frequency for the working machine, and control the electric motor so as to counteract waves with the resonance frequency.

At 10 in FIG. 2 a sensor detects an unwanted frequency. The sensor is preferably connected to a control unit for communication of signals from the sensor to the control unit. At 10 a signal is also sent from the control unit to a drive source, hereinafter exemplified by an electric motor, driving a hydraulic pump in order to adjust the rotation speed thereof. At 20 in FIG. 2 the rotation speed of the electric motor is controlled, preferably by a computer program in accordance with a computer model so as to counteract the unwanted frequency. In addition, if the displacement of a pump driven by the electric motor is controllable, a signal is sent from the control unit to the pump for adjusting the displacement based on the adjustment of the rotation speed of the electric motor. In addition or alternatively, the opening of a valve arranged between the pump and a consumer to be supplied by the pump can be changed. At 30 the displacement of the pump and/or the valve opening is changed. For example, if the speed of rotation of the electric machine has been increased at 20 the displacement is decreased at 30 in order to maintain the flow of hydraulic fluid at 40. Thus a consumer at 50 will receive substantially the same flow though the speed of rotation of the electric motor has been changed.

In an alternative embodiment of the invention the control of the pump and/or the valve at 30 is omitted. This will however result in a changed flow in comparison to the flow before the change of the rotation speed of the electric motor, and thus a change of the function of the consumer.

Although one or more sensors arranged on the working machine are preferably used for identifying the resonance frequency of the working machine, in another embodiment of the invention the frequency to be avoided can be a known in advance and/or by calculation. For example, when using a piston pump a predetermined resonance frequency could be identified by a calculation based on the number of pistons and the rotation speed of the pump motor. In an embodiment where the sensor is omitted and the control of the electric motor is based on already known frequencies to be avoided, it is important that the control unit receives signals corresponding to the current speed of rotation of the electric motor and the flow of hydraulic fluid at 40 in order to avoid a resonance frequency or a resonance frequency interval. In addition to the pressure drop over a valve and the opening area of the valve, information about the temperature and viscosity of the hydraulic fluid is preferably transferred to the control unit, as indicated at 5 60 and 70, which can be useful in order to calculate the hydraulic flow.

FIG. 3 is a schematic illustration of a working machine, and a hydraulic system of a working machine to which the method can be applied. The working machine comprises a body 103 and the hydraulic system is arranged on the body 103. The hydraulic system comprises a hydraulic machine 102, preferably a pump having an adjustable displacement, driven by a drive source 101 for providing, hydraulic fluid to at least one working function 105. Although the drive source is exemplified by an electric motor 101, another drive source could also possible be used, such as for example a hydraulic drive source. The drive source can be controlled so as to counteract waves with the resonance frequency. The drive source has preferably a variable rotation of speed, and the speed can preferably be varied independently of the rotation speed of the propulsion engine of the working machine.

A control valve 104 is arranged between the pump 102 and the working function or consumer 105. As also illustrated in FIG, 3, one or more sensors 106 can be arranged at different positions of the working machine for identifying a resonance frequency. The measuring can be performed for the hydraulic system of the working machine or another component of the working machine. In the embodiment illustrated in FIG. 3 the sensors 106 are acoustic sensors arranged on the body 103 of the working machine, the pump 102, the valve 104, and on a hydraulic cylinder of the working function 105, for measuring vibrations and/or sound. It should however be stressed that also other sensors can be used in some cases. For example, a sensor for measuring the pressure of the hydraulic fluid in the hydraulic system or a strain gauge arranged on a component of the hydraulic system or the body of the working machine.

By controlling the electric motor so as to counteract waves with the resonance frequency, vibrations can be reduced. This can be performed by changing the speed of rotation of the electric motor 101. The speed of rotation, i.e. the number of revolutions per unit time, can be increased or decreased depending on the current frequency to be avoided, the speed the working function 105 or consumer, etc. In order to compensate for the changed rotation of speed of the electric motor 101 the displacement of the hydraulic machine 102 can be changed so as to keep the hydraulic flow to the working function 105 substantially unchanged.

For example, the hydraulic pump 102 (130 cc and 7 pistons as an example) may have a rotation speed of 2000 rpm which gives piston pressure pulses with the frequency 233 Hz (2000/60*7). The theoretical maximal flow is 260 l/min (2000*130/1000). Suppose the current displacement of the pump is 50% of maximum, this will give a maximal flow of 130 l/min. In case an acoustic sensor 106 detects a resonance frequency in the hydraulic system that can be derived from the piston pressure pulses (233 Hz), the control unit 110 can change the rotation speed of the electric motor to 1800 rpm, for instance, so as to counteract the resonance frequency. The piston pressure pulses will then arise with the frequency 210 Hz (1800/60*7). In order to maintain the flow to the working function 105 supplied by the pump, the current displacement of the pump is increased from 50 to 55.5% (0.5*2000/1800).

Correspondingly, in a case where the rotation speed of the electric motor is increased the flow can be maintained by decreasing, the current displacement.

According, to an alternative embodiment an increased rotation of speed of the electric motor can be compensated for by draining hydraulic fluid from the hydraulic machine to a hydraulic tank so as to keep the hydraulic flow to the working function substantially unchanged.

As regards a resonance frequency that can be derived from the design of the hydraulic machine itself, such as a piston pump having a certain number o pistons which give rise to piston pressure pulses occurring with a given frequency depending on the rotation speed of the electric motor, in an alternative embodiment of the invention the rotation speed of the electric motor during one and the same rotation axis revolution of the electric motor can be varied. By varying the speed of rotation during one and the same rotation axis revolution the affect of the piston pressure pulses can be reduced at the same time as the total flow per revolution can be maintained. Hereby the resonance frequency and vibrations can be counteracted.

The method according to the invention can be used together with a certain working operation performed by means of the working function, A limitation on the speed rotation of the electric motor can be introduced during performance of said working operation so as to counteract or avoid waves with an unwanted resonance frequency. For example, an upper limitation on the speed rotation of the electric motor can be introduced. Hereby the speed of the working function used is also reduced, unless the displacement of the pump is changed for keeping the hydraulic flow unchanged. Such a limitation and control of the electric motor can be introduced by manipulating electrical signals from one or more operator levers 107 provided for manoeuvring the working function.

In another embodiment of the invention, a limitation on the output torque of the electric motor is introduced during performance of said working operation. In order to maintain the requisite pressure demanded by the working function the displacement of the pump has to be decreased which in turn implies that the hydraulic flow will decrease for a certain speed of rotation. A further pump can he used to maintain the flow and the speed of the working function. At the same time, the unwanted piston pressure pulsations can be reduced due to the decreased displacement of the first pump and/or by the fact that the further primp affects the pulsations in the hydraulic system.

The invention also relates to a device for reducing vibrations in a working machine. The device comprises a means for identifying a resonance frequency for the working machine, and a means for controlling the drive source so as to counteract waves with the resonance frequency. The identifying means can be any of the means already described hereinabove, such as an acoustic sensor for instance. The means for controlling the drive source, preferably an electric motor, can be a control unit having a computer program with code means, and this control unit can be constituted by the main control unit 110 for controlling the hydraulic system or be an integrated part thereof or be constituted by an additional separate control unit.

It is to be understood that the present invention is not limited to the embodiments described above and illustrated in the drawings; rather, the skilled person will recognize that many changes and modifications may be made within the scope of the appended claims.

1. A method for reducing vibrations in a working machine, the working machine comprising a hydraulic system with a hydraulic machine for providing hydraulic fluid to at least one working function, the hydraulic machine being driven by a drive source having a variable speed of rotation, comprising
identifying a resonance frequency for the working machine, and
controlling the drive source so as to counteract waves with the resonance frequency.

2. A method according to claim 1, comprising controlling the drive source by changing the speed of rotation of the drive source.

3. A method according to claim 2, comprising controlling the drive source by increasing the speed of rotation of the drive source.

4. A method according to claim 2, comprising controlling the drive source by decreasing the speed of rotation of the drive source.

5. A method according to claim 2, comprising compensating for the changed rotation of speed of the drive source by changing the displacement of the hydraulic machine so as to keep the hydraulic flow to the working function substantially unchanged.

6. A method according to claim 3, comprising compensating for the increased rotation of speed of the drive source by draining hydraulic fluid from the hydraulic machine to a hydraulic tank so as to keep the hydraulic flow to the working function substantially unchanged.

7. A method according to claim 2, comprising varying the speed of rotation of the drive source during one and the same rotation axis revolution of the drive source.

8. A method according to claim 1, comprising introducing a limitation on the speed rotation of the drive source during performance of a certain working operation.

9. A method according to claim 8, comprising introducing an upper limitation on the speed rotation of the drive source.

10. A method according to claim 1, comprising introducing a limitation on the output torque of the drive source during performance of a certain working operation.

11. A method according to claim 8, comprising using the working function for performance of the working operation.

12. A method according to claim 1, comprising controlling the drive source by manipulating electrical signals from one or more operator input means (107) provided for manoeuvring the working function.

13. A method according to claim 1, comprising identifying the resonance frequency by using one or more sensors arranged on the working machine.

14. A method according to claim 13, comprising sensing the resonance frequency by using one or more acoustic sensors.

15. A method according to claim 1, comprising identifying the resonance frequency for the hydraulic system of the working machine.

16. A method according to claim 1, comprising the drive source being an electric motor.

17. A method according to claim 1, comprising controlling the drive source independently of the speed of rotation of a propulsion engine of the working machine.

18. A device for reducing vibrations in a working machine, the working machine comprising a hydraulic system with a hydraulic machine for providing hydraulic fluid to a at least one working function, the hydraulic machine is arranged to be driven by a drive source, comprising means for identifying a resonance frequency for the working machine, and means for controlling the drive source so as to counteract waves with the resonance frequency.

19. A device according to claim 18, wherein the control means (110) is arranged for controlling the drive source constituted by an electric motor.

20. A working machine comprising a device according to claim 18.

21. A computer comprising code for performing the steps of claim 1.

22. A tangible, non-transitory computer readable medium comprising a computer program for performing the steps of claim 1.
